(19) United States
(12) Patent Application Publication
(10) Pub. No.: US 2015/0170300 A1
(43) Pub. Date: Jun. 18, 2015

(54) REAL ESTATE AGENT RELATIONSHIP MANAGEMENT

(71) Applicant: Zip Realty, Inc., Emeryville, CA (US)

(72) Inventors: James Wilson, Emeryville, CA (US); Colin McConnell, Emeryville, CA (US); Jeffrey McNeill, Emeryville, CA (US)

(21) Appl. No.: 14/565,090

(22) Filed: Dec. 9, 2014

Related U.S. Application Data
(60) Provisional application No. 61/917,700, filed on Dec. 18, 2013.

(51) Int. Cl. G06Q 50/16

(52) U.S. Cl. CPC G06Q 50/16

(57) ABSTRACT

A system comprising a computer-readable storage medium storing at least one program and a computer-implemented method for providing business relationship management services to a real estate agent is presented. Consistent with some embodiments, the method may include accessing information regarding actions performed by contacts of a real estate agent while using a network-based real estate information service. The method may further include assigning each of the contacts to a consumer classifications based on the actions performed by the contacts. The method further includes receiving, from the real estate agent, information defining an on-going communication strategy with a specified consumer classification of the contacts, and implementing the communication strategy with respect to the specified consumer classification.

### CROSS REFERENCE TO RELATED APPLICATIONS

This application claims the benefit of U.S. Provisional Patent Application Ser. No. 61/917,700, filed Dec. 18, 2013, which is incorporated by reference herein in its entirety.

### TECHNICAL FIELD

This application relates generally to data processing within a network-based system and, more specifically, to features of a network-based real estate marketing platform.

### BACKGROUND

Currently, a vast amount of real estate transactions are performed online. For example, real estate agents may take advantage of network-based real estate services to perform tasks such as drafting and transmitting offers for purchases of properties. Consumers, on the other hand, may be able to utilize other network-based real estate services to search through online property listings or schedule tours with real estate agents. Current technologies are, however, limited in functionality and are deficient in many aspects that affect both consumers and real estate agents.

For example, appraisers, investment professionals, and lending institutions often use an automated valuation model (AVM) in their analysis of real estate, but traditional AVM-based valuation tools are often limited in availability to those who are not an appraiser or investment professionals. This puts property owners at a disadvantage and leaves potential sellers in the real estate market without a reliable indication of the true value of a real estate property. Further, a potential seller who is able to access an AVM-based valuation may not have an accurate perspective regarding the actual amount a particular property will sell for due to the wide variance in the valuations provided by existing models. Additionally, given the vast quantity of real estate agents in the market, sellers of real estate property who wish to employ the services of a real estate agent may encounter additional difficulties in selecting a suitable agent.

Consumers who use these network-based real estate services are often assigned to a particular real estate agent who is responsible for fostering a business relationship with the consumers he or she is assigned to ensure that they stay committed to engaging in real estate transactions using the real estate agent. Given the large amount of consumers that utilize these services, real estate agents may be overwhelmed with the number of consumers for which they are responsible. Real estate agents may waste considerable time and effort using multiple task and contact management techniques in attempting to build and maintain relationships with these consumers. Further, the functionality of current technologies does not address the various nuances and parameters that need to be considered for effective relationship maintenance.

### BRIEF DESCRIPTION OF THE DRAWINGS

Various ones of the appended drawings merely illustrate example embodiments of the present invention and cannot be considered as limiting its scope.

FIG. 1 is a block diagram illustrating an abstract view of various functional components of a real estate marketing platform, according to an example embodiment.

FIG. 2 is a block diagram illustrating an architectural view of a networked real estate marketing platform, according to an alternative embodiment, having a client-server architecture configured for exchanging data over a network.

FIG. 3 is a high-level entity-relationship diagram, illustrating various tables that may be maintained within a database of the network-based system, according to an example embodiment.

FIG. 4 is a block diagram illustrating various functional modules of a real estate seller application, which is provided as part of the real estate marketing platform, consistent with some embodiments.

FIGS. 5A and 5B are flowcharts illustrating a method for providing property valuation services, according to an example embodiment.

FIG. 6A is an interface diagram illustrating a user interface for receiving a property identifier, according to an example embodiment.

FIG. 6B is an interface diagram illustrating an interface for presenting multiple property valuations, according to an example embodiment.

FIG. 6C is an interface diagram illustrating an interface for presenting comparable property information to a consumer, according to an example embodiment.

FIG. 6D is an interface diagram illustrating a user interface for presenting a group of suggested agents, according to an example embodiment.

FIG. 7 is a block diagram illustrating the various functional modules forming a relationship management application, which is provided as part of the real estate marketing platform, according to an example embodiment.

FIG. 8 is an interface diagram illustrating an interface for managing relationships of a real estate agent, according to an example embodiment.

FIG. 9 is an interface diagram illustrating further details of a portion of the interface for managing relationships of a real estate agent, according to an example embodiment.

FIG. 10 is an interface diagram illustrating an interface for establishing a communication strategy for a group of contacts, according to an example embodiment.

FIG. 11 is an interface diagram illustrating an interface including notifications provided by the real estate marketing platform on a mobile device, according to an example embodiment.

FIG. 12 is a flowchart illustrating a method for determining an engagement score, according to an example embodiment.

FIG. 13 is a flowchart illustrating a method for assigning a group of consumers to applicable consumer classifications, according to an example embodiment.

FIG. 14 is a flowchart illustrating a method for managing relationships of a real estate agent, according to an example embodiment.

FIG. 15 is a diagrammatic representation of a machine in the example form of a computer system within which a set of instructions for causing the machine to perform any one or more of the methodologies discussed herein may be executed.

### DETAILED DESCRIPTION

Reference will now be made in detail to specific example embodiments for carrying out the inventive subject matter. Examples of these specific embodiments are illustrated in the accompanying drawings. It will be understood that they are not intended to limit the scope of the claims to the described embodiments. On the contrary, they are intended to cover alternatives, modifications, and equivalents as may be included within the scope of the disclosure. In the following description, specific details are set forth in order to provide a thorough understanding of the subject matter. Embodiments may be practiced without some or all of these specific details.

Aspects of the present disclosure relate to a real estate marketing platform that provides various real estate marketing services to both consumer users (also referred to herein as “consumers”) and real estate agent users (also referred to herein as “real estate agents” or simply “agents”). The various systems and methods discussed herein may assist consumers who are interested in selling property to determine how much the property may be worth. These property value estimates (also referred to as “valuations”) may be based on information from various sources such as automated valuation models (AVM), comparable property prices, user provided information, user activity, and local real estate agents. For purposes of the present disclosure and the claims, the terms “property,” and “real estate property” shall be synonymous and may refer to any house or structure and the land on which they sit or a piece of undeveloped land including any natural resources (e.g. crops, minerals, or water) located on the land. The term “automated valuation model” refers to a service that provides real estate property valuations using mathematical modeling.

Example embodiments include a method that includes receiving a property identifier such as an address of a particular property a consumer may be interested in selling. The method may further include obtaining and presenting multiple AVM-based valuations for the property. An additional valuation may be determined and presented based on the prices of other properties that are similar to the property the consumer is interested in selling. After presenting the consumer with the AVM-based and comparable-based valuations for the property, the method may further include presenting a group of suggested real estate agents to assist the consumer in selling the property.

Aspects of the present disclosure relate to systems and methods to assist real estate agents manage business relationships. These business relationships may include a pool of contacts which a real estate agent has been assigned or has acquired through other means. The pool of contacts may comprise consumers of the real estate marketing platform. In managing these business relationships, real estate agents may desire to establish on-going communications with his or her contact pools. The real estate agent may desire to vary the style, content, or frequency of respective communications depending on likelihood that the consumer will utilize the services of the agent and the type of relationship that exists with the consumer. Accordingly, example embodiments relate to scoring consumers of a real estate marketing platform according to their respective levels of engagement with the platform and the agent. Further example embodiments related to segmenting and categorizing a group of contacts of a real estate agent. Additional example embodiments related to defining and implementing communication strategies to establish on-going communications with a group of contacts. Consistent with some embodiments, a real estate agent may specify multiple communication strategies for contacts of their contact pool. Each of such communication strategies may specify a series of messages directed to a particular consumer category or sub-category, to consumers of various levels of engagement, or combinations of both.

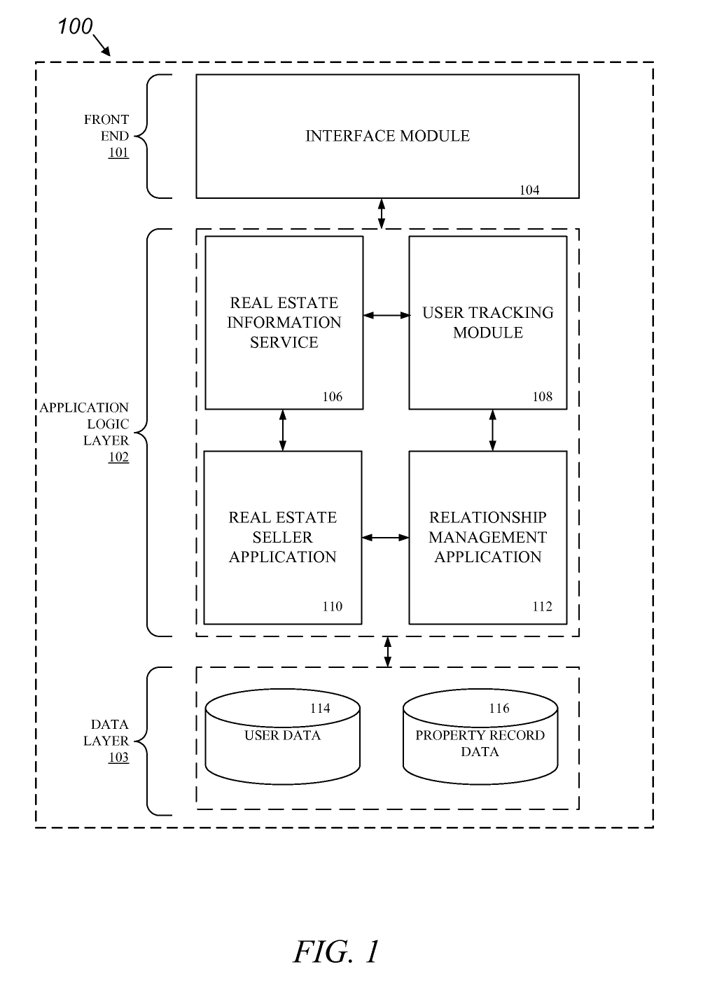

FIG. 1 is a block diagram illustrating an abstract view of various functional components of a real estate marketing platform 100, according to an example embodiment. It will be appreciated that although the functional components of the real estate marketing platform 100 are discussed in the singular sense, multiple instances of each component may be employed. The real estate marketing platform 100 may correspond to a real estate website (e.g., www.ziprealty.com) and may provide various real estate marketing services to both consumers and real estate agents. As shown in FIG. 1, the real estate marketing platform 100 is generally based on a three-tiered architecture comprising a front-end layer 101, application logic layer 102, and a data layer 103. As is understood by those skilled in the relevant computer and Internet-related arts, each module or application shown in FIG. 1 represents a set of executable software instructions and the corresponding hardware (e.g., memory and processor) for executing the instructions. To avoid obscuring the inventive subject matter with unnecessary detail, various functional modules and engines that are not germane to conveying an understanding of the inventive subject matter have been omitted from FIG. 1. However, various additional functional modules and engines may be used with the real estate marketing platform 100 to facilitate additional functionality that is not specifically described herein. Furthermore, the various functional modules and engines depicted in FIG. 1 may reside on a single server, or may be distributed across several servers in various arrangements. Moreover, although depicted in FIG. 1 as a three-tiered architecture, the inventive subject matter is by no means limited to such an architecture.

As shown in FIG. 1, the front end layer 101 includes an interface module 104 (e.g., a web server and application program interface (API)), which receives requests from various client devices of various users, and communicates appropriate responses to the requesting client devices including instructions which cause the presentation of any one of the interfaces discussed herein. For example, the interface module 104 may receive requests in the form of Hypertext Transport Protocol (HTTP) requests or other web-based, API requests. The interface module 104 may include an API module (not shown), which is coupled to and provides programmatic interfaces to the application logic layer 102. As such, the API module of the interface module 104 may enable third-party applications to invoke the functionality of the real estate marketing platform 100.

The application logic layer 102 of the real estate marketing platform 100 may include at least one server that includes at least one processing device configured to implement at least the respective methods discussed herein. As illustrated by FIG. 1, the application logic layer 102 may include a real estate information service 106, a user tracking module 108, a real estate seller application 110, and a relationship management application 112. The real estate information service 106 may host information for real estate properties and may maintain several listings of properties for sale. Each property listing may have a dedicated web page (or a set of web pages) to provide information for each piece of property. This information may include pictures, floor plans, a geographic area in which the property is located along with other attributes of the property (e.g., price, size, year built, date listed, price per square foot, number of bedrooms, number of bathrooms, and property type). Online property listings may also provide a user with the ability to print the listing, save the listing for later viewing, share the listings with another user, request a visit to the property, request more information about the property, and get directions to the property.

The real estate information service 106 may provide users with the ability to quickly filter, sort, and search through property listings using one or more search parameters. For example, the real estate information service 106 may enable a user to perform a search query for properties within a particular geographic area. As referenced above, the geographic area in which the property is located may be maintained on each property listing page. A geographic area search may, for example, limit the search to property within a particular city, neighborhood, subdivision, postal code, or school district. As another example, the real estate information service 106 may enable a user to perform a search query for properties with certain attributes, which are maintained as part of the corresponding property listing. Attributes of a property may, by way of non-limiting example, include a property type (e.g., single family house, multi-family house, condo, land, or apartment), a size (e.g., square footage), a number of bedrooms, a number of bathrooms, an exact price, a price range, a price decile (e.g., “third decile in market”), a year built, a date listed, a number of days on the market, or a transaction type (e.g., foreclosure, short sale, new construction, tenancy in common, or fixer upper).

The user tracking module 108 may be a hardware implemented module or software executed by general purpose or special purpose hardware or instructions stored on a computer-readable medium that is operative to track the activity of users with respect to the real estate marketing platform 100, and in particular, the real estate information service 106. The user tracking module 108 may store the respective activities of consumers as consumer activity data, for example, in database 114.

The user tracking module 108 may track several types of user activity, which are referenced above with respect to the functionalities of the real estate information service 106. The user tracking module 108 may track consumer activity for each consumer of the real estate marketing platform 100 with respect to the functionalities discussed herein. Before being able to engage in certain activities with the real estate information service 106, a consumer may be prompted to set up a user profile. Consistent with some embodiments, the consumer activity data may be maintained as part of a user profile by the real estate marketing platform 100.

Consumer activity may, for example, include the following actions: setting up an account, subscribing to alerts or notifications, logging on to an account (e.g., via mobile application or web client), viewing an agent profile page, viewing agent ratings, performing a property search query using location or attribute parameters, saving a property search, viewing an online web page for a property listing, printing a property listing, saving a listing for later viewing, sharing a listing with another user (e.g., via e-mail or social network), requesting or scheduling a visit to a property, requesting more information about a property, requesting directions to a property, performing a geopositional property search query, performing an image-recognition based property search query, or any other actions a consumer may take on the real estate information service 106.

The real estate seller application 110 may provide a number of services to sellers or potential sellers of real estate property. For example, the real estate seller application 110 may provide current and historical property valuations for real estate properties along with listings for comparable real estate properties. The real estate seller application 110 may also assist sellers to connect with a real estate agent who may assist the seller in selling real estate properties.

Each consumer (e.g., a buyer or seller) with a user account on the real estate marketing platform 100 may be assigned to an agent. The particular agent assigned to a consumer may be based on attributes of the agent, activities of the consumer, a location of the consumer, a location of the subject property, seasonality, or any combination thereof. An agent may be assigned to a group of consumers.

As each of the consumers may have different goals and may be at different points in the real estate purchasing process (e.g., casually enquiring as opposed to actively purchasing), providing each consumer with the appropriate level of customer service may be difficult for an agent to manage. To this end, the real estate marketing platform 100 includes a relationship management application 112 that is operative to provide relationship management services to assist agents in managing a group of consumers. For example, the relationship management application 112 may automatically segment and classify a group of consumers from a contact pool based on a level of engagement of each of the consumers with the real estate information service 106. The relationship management application 112 may also provide services to enable efficient communication for agents with consumers. For example, the relationship management application 112 may work in conjunction with the interface module 104 to provide an agent with a dashboard interface for establishing on-going communications with consumers using customizable message scripts.

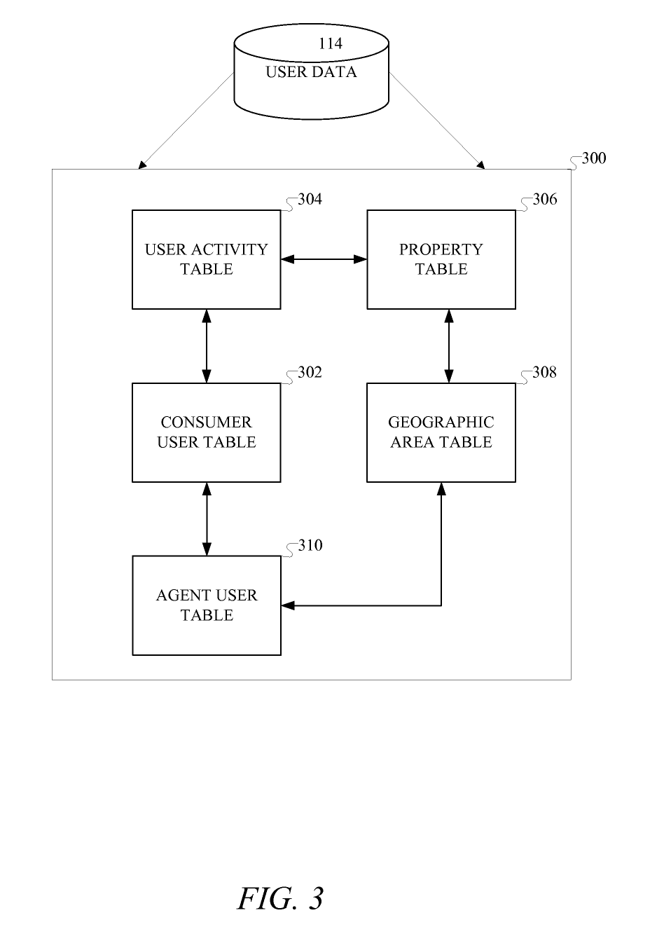

As illustrated in FIG. 1, the application logic layer 102 may be communicatively coupled to the data layer 103. The data layer 103 may include multiple databases, including databases 114 and 116. The database 114 may store user data including the user activity information retrieved by the user tracking module 108. Examples of tables stored in the database 114 will be discussed in greater detail below in reference to FIG. 3.

The database 116 may store a record for one or more properties maintained by the real estate information service 106. Each record may include an identifier, an address, and other information pertaining to one or more real estate properties. This information may be maintained for properties that are currently on the market and listed by real estate information service 106 or by a third party server (not shown). The property record database 116 may also include information for other properties that are not currently listed by a listing service and/or are not on the market. The information maintained for each property may include geographic area location information. Geographic area information may, for example, include a state, a city, a postal code, a neighborhood, a county, a school district, or a metropolitan area.

The property record database 116 may also include specific attributes of each property including, for example, a property type (e.g., single family house, multi-family house, condo, land, or apartment), a property size (e.g., square footage), a number of bedrooms, a number of bathrooms, a price, a year built, a date listed, a number of days on the market, a transaction type (e.g., new, resale, standard, foreclosure, short sale, tenancy in common, or fixer upper).

In one embodiment, property record information for a particular property stored in the databases 116 may be obtained from a user through the interface module 104. In another embodiment, property record information for a particular property stored in the databases 116 may be obtained via an API module (not shown) from public and private (e.g., multiple listing service (MLS)) property listing databases.

While the real estate information service 106, real estate seller application 110, and relationship management application 112 are shown in FIG. 1 to form part of the real estate marketing platform 100, it will be appreciated that, in alternative embodiments, the real estate information service 106, real estate seller application 110, and relationship management application 112 may form part of or operate in conjunction with a service that is separate and distinct from the the real estate marketing platform 100. The various functional components of the application logic layer 102 may also be implemented as standalone systems or software programs, which do not necessarily have networking capabilities. It shall be appreciated that although the various functional components of the real estate marketing platform 100 are discussed in the singular sense, multiple instances of one or more of the various functional components may be employed.

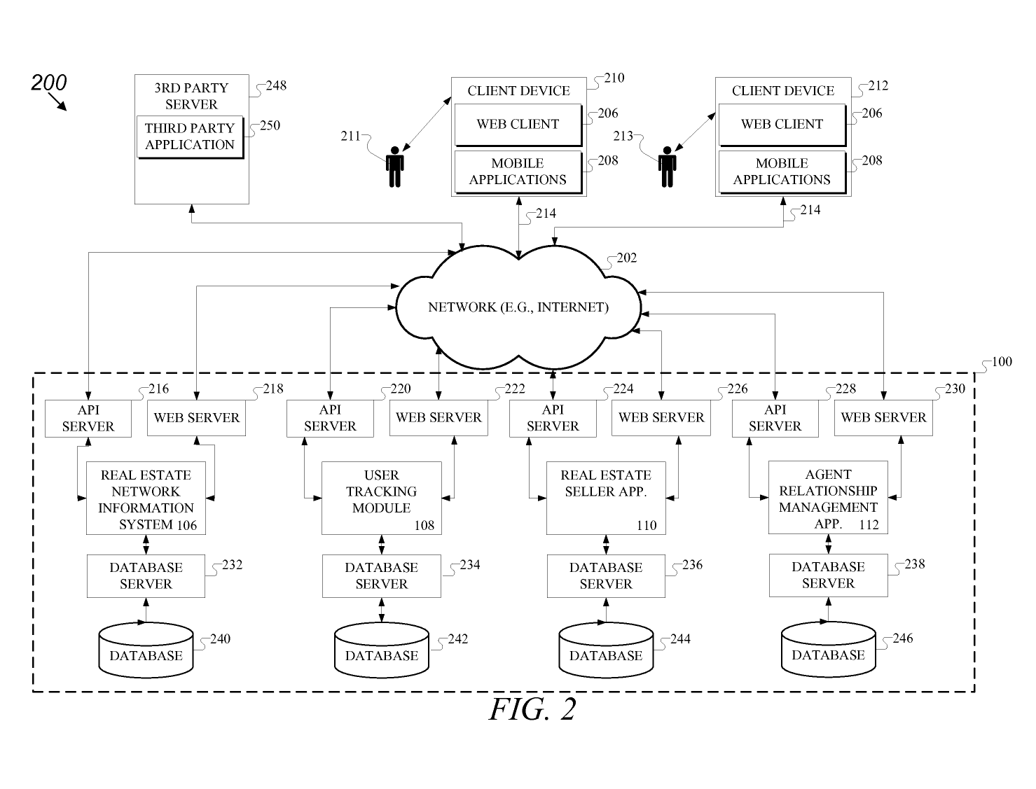

FIG. 2 is a block diagram illustrating an architectural view of a networked real estate marketing platform 200, according to an alternative embodiment, having a client-server architecture configured for exchanging data over a network. It will be appreciated that although the components of the networked system 200 are discussed in the singular sense, multiple instances of each component may be employed. The networked system 200 provides server-side functionality, via a network 202 (e.g., the Internet or wide area network (WAN)), for each real estate information service 106, user tracking module 108, real estate seller application 110, and relationship management application 112, to one or more clients. For example, FIG. 2 illustrates client devices 210 that represent example devices that can be utilized by users to perform various activities associated with the real estate marketing platform 100. The client devices 210 may be any of a variety of types of devices such as a personal computer, a laptop computer, a cellular telephone, a personal digital assistant (PDA), a personal navigation device (PND), a handheld computer, a tablet computer, a notebook computer, or other type of movable device. As illustrated, the first client device 210 is used by an agent 211, while the second client device 212 is used by a consumer 213.

The client device 210 may be executing conventional web browser applications (e.g., web client 206) or mobile applications 208 that have been developed for a specific platform to include any of a wide variety of mobile devices and operating systems. For example, the client device 210 may be executing a mobile application 208 specifically developed for interacting with the real estate marketing platform 100.

The mobile application 208 may provide enhanced search functionality to the consumer 213. For example, the real estate information service 106 may utilize the Global Positioning System (GPS) functionality of the client device 210 to provide the consumer 213 with the ability to perform a geopositional property search query. A geopositional property search query may allow the consumer 213 to perform a property search query for property listings within a specified distance from the location of the consumer 213.

The mobile application 208 may further utilize a camera (e.g., included in the client device 210) combined with existing image-recognition and geopositioning techniques to provide a user with an image-recognition based property search query. An image-recognition based property search query may identify a property from an image and provide the consumer 213 with the corresponding online property listing. For example, the real estate information service 106 may receive an image of a particular property from the client device 210 of the consumer 213, and based on the recognition of the particular property, the real estate information service 106 may provide the consumer 213 with the corresponding property listing for the particular property. In another example, the real estate information service 106 may receive an image from the client device 210 of a real estate sign associated with a particular property having a unique identifier (e.g., quick response (QR) code or bar code) identifying the particular property. In this example, the real estate information service 106 may provide the consumer 213 with the property listing corresponding to the property based on recognition of the unique identifier.

The client devices 210 may interface via a connection 214 with a communication network 202. Depending on the form of the client devices 210, any of a variety of types of connections 214 and communication networks 202 may be used. For example, the connection 214 may be a Code Division Multiple Access (CDMA) connection, a Global System for Mobile communications (GSM) connection, or other type of cellular connection. Such connection 214 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, or other data transfer technology (e.g., fourth generation wireless, 4G networks). When such technology is employed, the communication network 202 may include a cellular network that has a plurality of cell sites of overlapping geographic coverage, interconnected by cellular telephone exchanges. These cellular telephone exchanges may be coupled to a network backbone (for example, the public switched telephone network (PSTN), a packet-switched data network, or to other types of networks).

In another example, the connection 214 may be Wireless Fidelity (Wi-Fi, IEEE 802.11x type) connection, a Worldwide Interoperability for Microwave Access (WiMAX) connection, or another type of wireless data connection. In such an embodiment, the communication network 202 may include one or more wireless access points coupled to a local area network (LAN), a wide area network (WAN), the Internet, or other packet-switched data network. In yet another example, the connection 214 may be a wired connection, for example an Ethernet link, and the communication network may be a LAN, a WAN, the Internet, or other packet-switched data network. Accordingly, a variety of different configurations are expressly contemplated.

Each API server 216, 220, 224, and 228 and each web server 218, 222, 226 and 230 are coupled to, and provide programmatic and web interfaces to, the real estate information service 106, user tracking module 108, real estate seller application 110, and relationship management application 112, respectively. The real estate information service 106, user tracking module 108, real estate seller application 110, and relationship management application 112 are, in turn, shown to be respectively coupled to databases servers 232, 234, 236, and 238 that facilitate access to databases 240, 242, 244, and 246, respectively. The databases 240, 242, 244, and 246 may correspond to the databases 114 and 116.

As illustrated by FIG. 2, the web client 206 accesses the real estate marketing platform 100 via the web interface supported by each of the web servers 218, 222, 226 and 230, respectively. Similarly, the mobile applications 208 access the various services and functions provided by the real estate information system 106 and modules 108, 110, and 112 via the programmatic interface provided by each of the API servers 216, 220, 224, and 228, respectively.

FIG. 2 also illustrates a third party server 248 as having programmatic access to the network 202. The third party server 248 may be coupled via an API server to the communication network 202, for example, via wired or wireless interfaces. The third party server 248 may, utilizing information retrieved from the communication network 202, support one or more third party applications 250. The third party application 250 may be a website hosted by the third party that supports or utilizes one or more functions or features of the real estate marketing platform 100.

Each of the real estate information service 106, user tracking module 108, real estate seller application 110, and relationship management application 112 may provide a number of functions and services, as discussed herein, to users that may access each individually. While the real estate information service 106, user tracking module 108, real estate seller application 110, and relationship management application 112 are shown in FIG. 2 to be separate and distinct modules, it will be appreciated that, in alternative embodiments, the real estate information service 106, user tracking module 108, real estate seller application 110, and relationship management application 112 may form one integrated networked system, such as the system illustrated by FIG. 1. Further, while the system 200 shown in FIG. 2 employs a client-server architecture, the present invention is, of course, not limited to such an architecture, and could equally well find application in a distributed, event-driven, or peer-to-peer architecture system, for example. The real estate information service 106, user tracking module 108, real estate seller application 110, and relationship management application 112 could also be implemented as standalone software programs, which do not necessarily have networking capabilities.

FIG. 3 is a high-level entity-relationship diagram, illustrating various tables 300 that may be maintained within the databases 114. A consumer table 302 contains a record for each consumer 213 that has interacted with the real estate marketing platform 100. The consumer table 302 may include an identifier for each consumer such as a name, a username, an e-mail address, or unique numerical identifier. The consumer table 302 may further include at least one consumer classification for each consumer. The consumer classifications may, for example, include a closed client, a transacting client, an offering client, a listing client, a showing client, a pre-listing client, a responsive prospect, an unresponsive prospect, a cold prospect, a reassigned lead, or a new lead

As illustrated by FIG. 3, the tables 300 may include a user activity table 304 that stores a historical record of user activity for each type of action a user may perform while using the real estate marketing platform 100. In some embodiments, the user activity table 304 may include an aggregate value for the number of times certain actions are performed. For example, the user activity table 304 may include a total number of times a particular property attribute was used as a parameter in a property search query, a total number of times a particular geographic area was used as a parameter in a property search query, a total number of page views of an online web page for a property listing, a total number of times a property listing was printed, a total number of times a property listing was saved for later viewing, a total number of times a property listing was shared with another user, a total number of requests to view a property, a total number of requests for more information about a property, or a total number of requests for directions to a property. Entries in the user activity table 304 may be linked to one or more records of the consumer table 302, so as to provide a record of user activity for each consumer of the real estate marketing platform 100.

A property table 306 contains a record for each real estate property having a property listing page by the real estate information service 106, and may include an identifier, property address, or uniform resource locator (URL) corresponding to the property listing page. Entries in the property table 306 may be linked to one or more applicable records of the user activity table 304.

The tables 300 may also include a geographic area table 308 in which is maintained a record for each geographic area in which a property listed by the real estate information service 106 is located. As referenced above, a geographic area may, for example, include a state, a city, a postal code, a neighborhood, a county, a school district, or a metropolitan area. Each property record within the property table 306 may be linked to one or more geographic area records within the geographic area table 308, so as to associate a particular property listing and one or more geographic areas.

An agent table 310 contains a record for each real estate agent of the real estate marketing platform 100, and may include an identifier of the agent such as a name, a username, an e-mail address, a realtor license number, or some other unique numerical identifier. Each consumer for which a record is maintained in the consumer table 302 may be linked to one or more records of the agent table 310, so as to associate a consumer with an assigned agent. Further, each record in the agent table 310 may be linked to one or more records in the geographic area table 308, so as to associate an agent with the geographic area in which they serve.

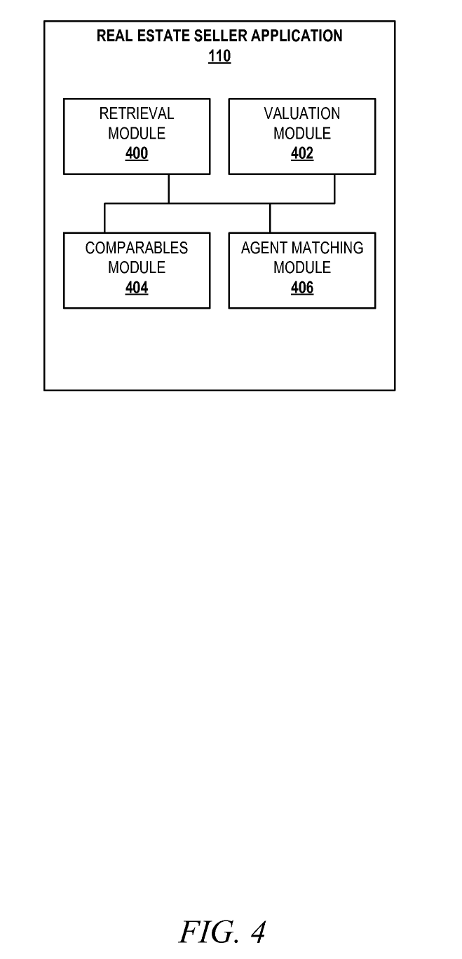

FIG. 4 is a block diagram illustrating various functional modules of a real estate seller application 110, which is provided as part of the real estate marketing platform 100, consistent with some embodiments. The real estate seller application 110 is illustrated to include an information retrieval module 400, a valuation module 402, a comparables module 404, and an agent matching module 406, all configured to communicate with each other (e.g., via a bus, shared memory, a switch, or application programming interfaces (APIs)). The various modules of the real estate seller application 110 may, furthermore, access the databases 114 and 116, and each of the various modules of the real estate seller application 110 may be in communication with one or more of the third party applications 250. Further, while the modules of FIG. 4 are discussed in the singular sense, it will be appreciated that in other embodiments multiple modules may be employed.

The information retrieval module 400 may be a hardware implemented module or software executed by general purpose or special purpose hardware or instructions stored on a computer readable medium that is operative to retrieve property information about real estate properties. The property information may include geographical information for the property along with attributes of the property such as a property type (e.g., single family house, multi-family house, condo, land, or apartment), a property size (e.g., square footage), a number of bedrooms, a number of bathrooms, a price, a year built, a date listed, a number of days on the market, a transaction type (e.g., new, resale, standard, foreclosure, short sale, tenancy in common, or fixer upper). The property information may be retrieved by the information retrieval module 400 from publically available records or from licensed data provided by a third party.

The valuation module 402 may be a hardware implemented module or software executed by general purpose or special purpose hardware or instructions stored on a computer readable medium that is operative to obtain AVM-based valuations for real estate properties. Valuations for a particular property may be obtained from multiple different AVMs. The valuations provided by respective AVMs may be based on a combination of various factors that may be assigned varied weights depending on the AVM. The factors used by AVMs in determining a valuation may, for example, include comparable property sale prices, prior surveyor valuations, local historical housing price trends, geographic information, and property attributes of the subject property. Consistent with some embodiments, the valuations may be retrieved (e.g., via API) by the valuation module 402 from one or more third party AVMs (e.g., hosted by third party server 248). Consistent with some embodiments, the valuation module 402 may include an AVM for determining at least one valuation for subject properties.

The comparables module 404 may be a hardware implemented module or software executed by general purpose or special purpose hardware or instructions stored on a computer readable medium that is operative to identify properties listed for sale that are comparable to a subject property (referred to herein as “comparable properties”). The comparable properties may be comparable in that they share at multiple attributes in common with the subject property. For example, a 2 bedroom, 2 bathroom house is a comparable property for a subject property having 2 bedrooms and 2 bathrooms. The comparables module 404 may identify comparable properties from a multiple listing service (MLS) database or from other publically available listings services.

The comparables module 404 may also be configured to determine valuations for properties based on prices (e.g., listing prices or sale prices) of comparable properties (also referred to as “comparable valuations” or “comparable-based valuations”). This process may comprise calculating a statistical summation (e.g., mean, mode, or median) of prices of a set of comparable properties.

The agent matching module 406 may be a hardware implemented module or software executed by general purpose or special purpose hardware or instructions stored on a computer readable medium that is operative to identify real estate agents that may potentially assist the consumer 213 in selling a subject property. Consistent with some embodiments, the agent matching module 406 may use property information retrieved by the information retrieval module 400 to identify such agents. For example, the particular agents identified by the agent matching module 406 may be based on location of the subject property relative to a geographic area served by particular agents. The agents identified by the agent matching module 406 may be presented to the consumers 212 as suggested agents.

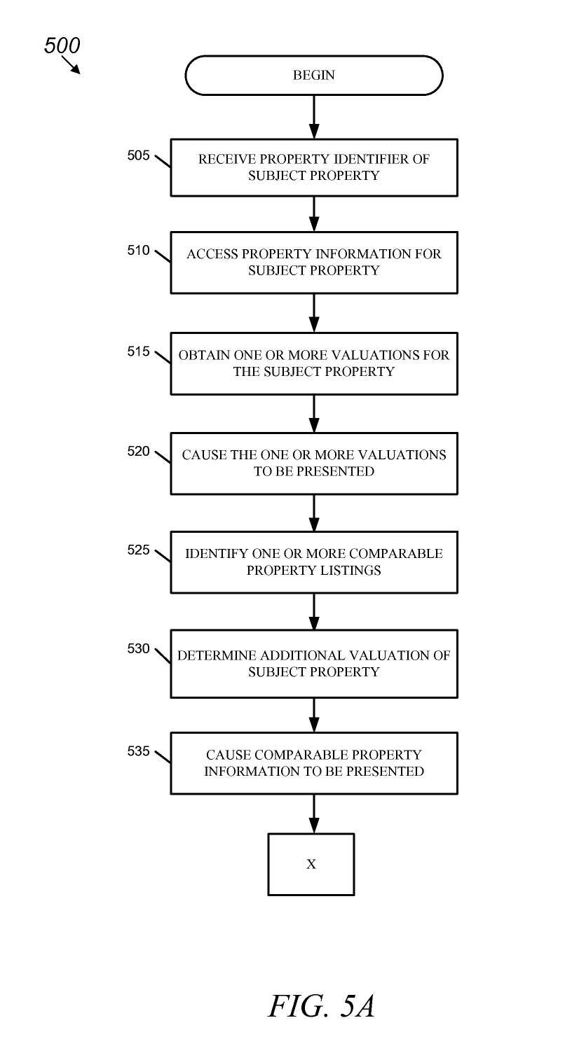

FIGS. 5A and 5B are flowcharts illustrating a method 500 for providing property valuation services, according to an example embodiment. The method 500 may be embodied in computer-readable instructions for execution by one or more processors such that the steps of the method 500 may be performed in part or in whole by the real estate seller application 110. In particular, the method 500 may be carried out by the modules forming the real estate seller application 110, and accordingly, the method 500 is described below by way of example with reference thereto. However, it shall be appreciated that the method 500 may be deployed on various other hardware configurations and is not intended to be limited to the modules of the real estate seller application 110.

At operation 505, the real estate seller application 110 working in combination with the interface module 104 may receive a property identifier from a client device (e.g., client device 210) of a consumer (e.g., consumer 213). The property identifier identifies a property that is to be the subject of the method 500 (hereinafter referred to as the “subject property”). In some instances, the subject property may be a property owned by the consumer. The property identifier may be an address, location coordinates, or another such identifier that may be used to identify a subject property.

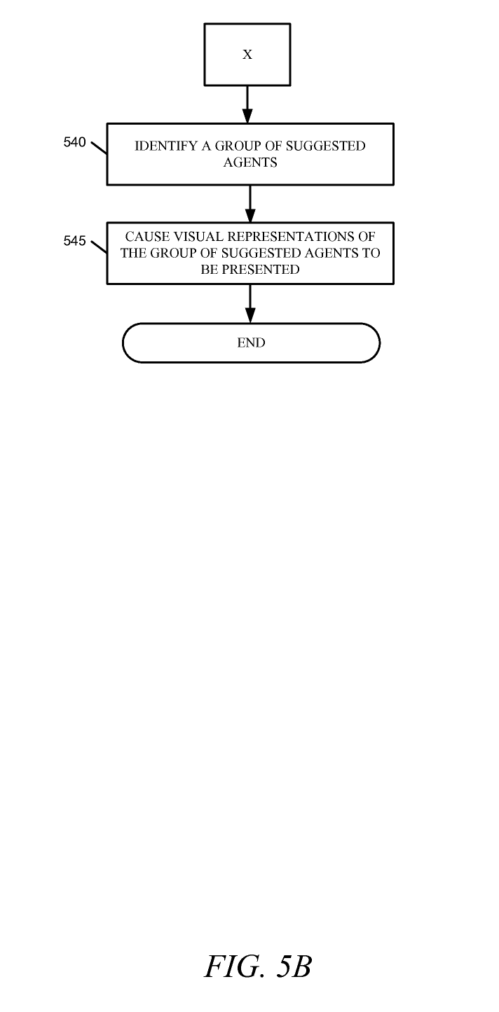

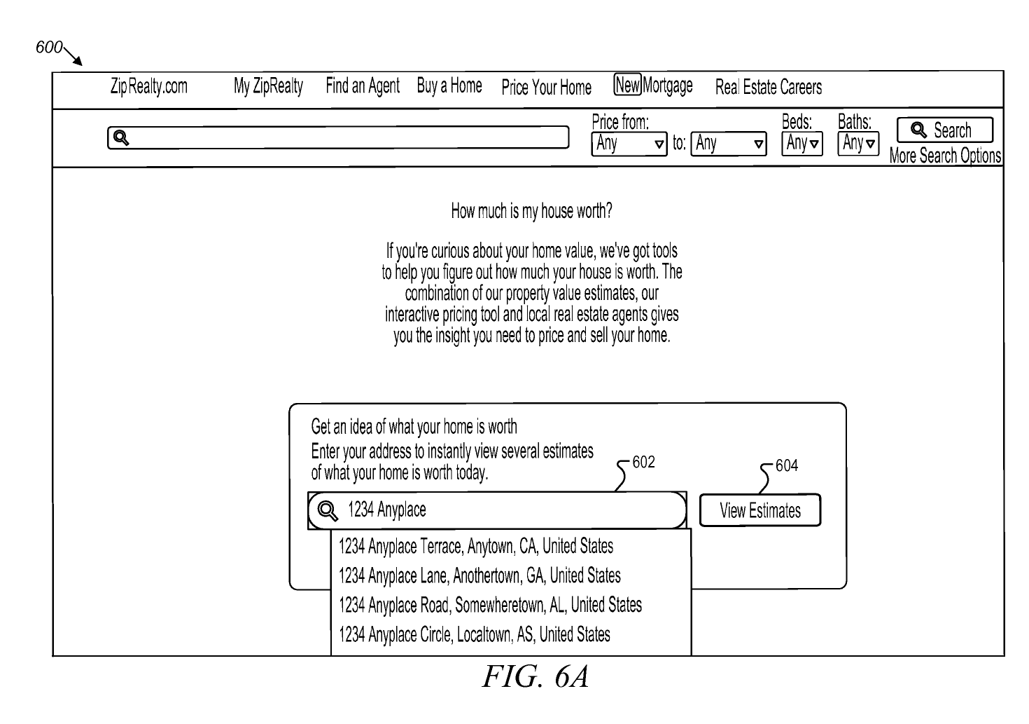

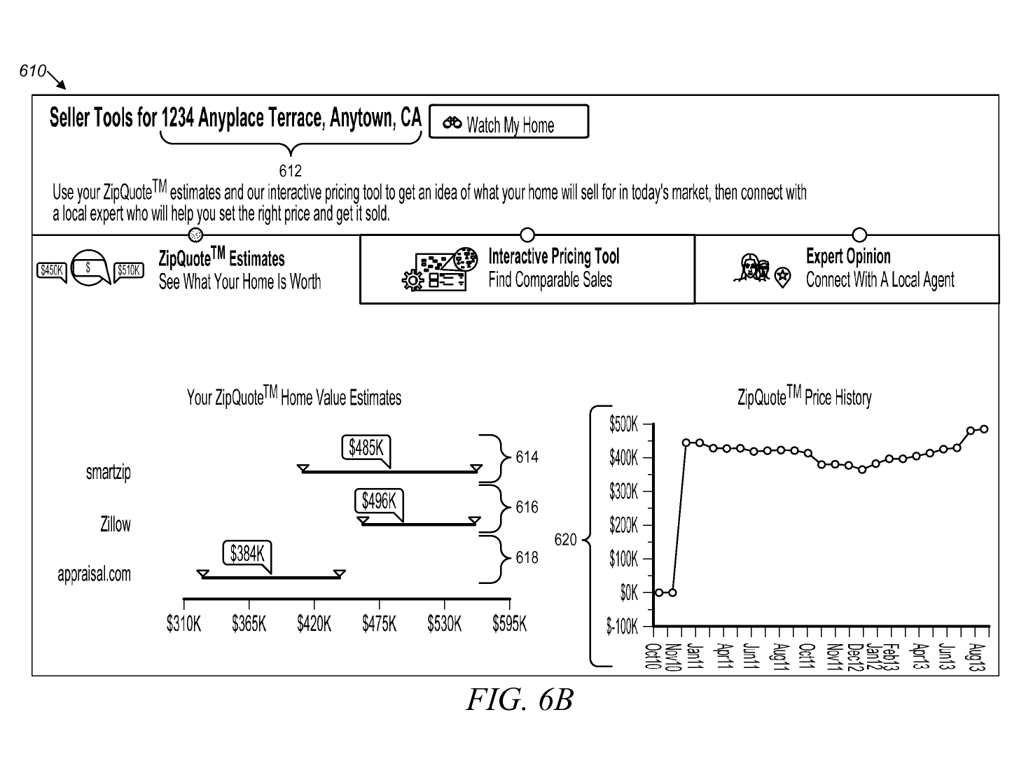

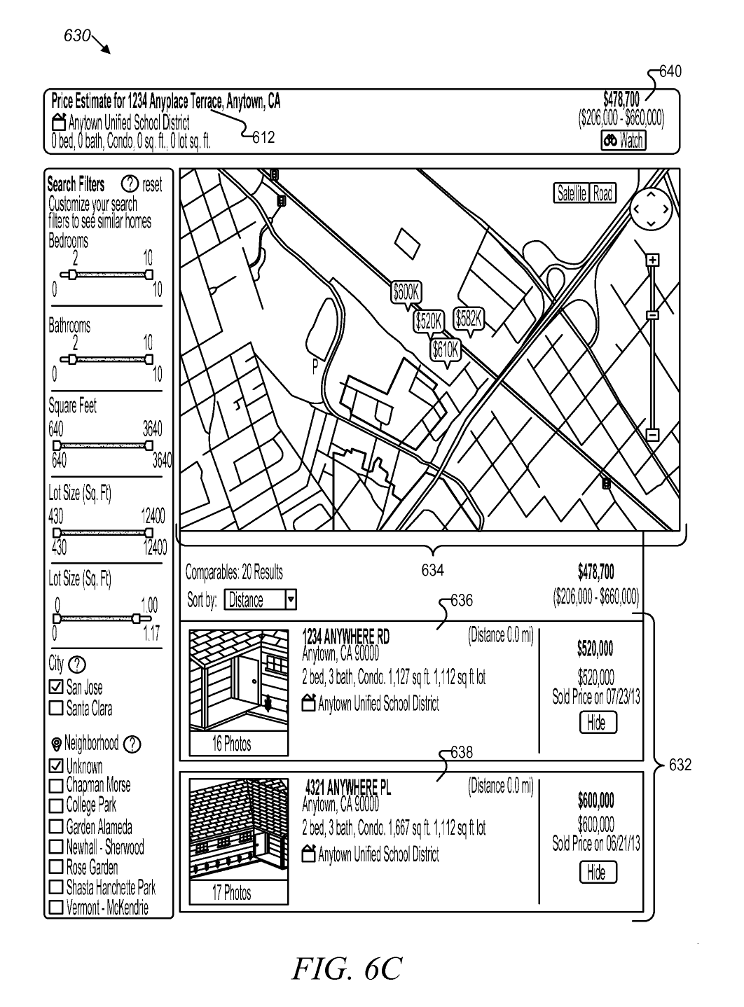

For example, FIG. 6A is an interface diagram illustrating a user interface 600 for receiving a property identifier, according to an example embodiment. As shown in FIG. 6A, the interface 600 includes a user input field 602 for entering the property identifier, which in this example is an address. The interface module 104 may, upon detecting user input, provide a drop down list of address suggestions in the interface 600, from which the consumer may select the subject property. Upon selection of button 604 (e.g., by clicking the button 604), the property identifier entered into the user input field 602 is received by the real estate seller application 110.

Returning to FIG. 5A, at operation 510, the retrieval module 400 may use the property identifier to access property information about the subject property. The property information may include geographical information for the property (e.g., a location) along with attributes of the property such as a property type (e.g., single family house, multi-family house, condo, land, or apartment), a property size (e.g., square footage), a number of bedrooms, a number of bathrooms, a price, a year built, a date listed, a number of days on the market, a transaction type (e.g., new, resale, standard, foreclosure, short sale, tenancy in common, or fixer upper). The property information may be retrieved by the retrieval module 400 from publically available records or from licensed data provided by a third party.

At operation 515, the valuation module 402 obtains one or more valuations for the subject property. In instances in which multiple valuations are obtained by the valuation module 402, the multiple valuations may be obtained from multiple different AVMs. The valuations obtained by the valuation module 402 may be calculated using known methods, and may be based on a weighted combination of comparable home sales prices, prior surveyor valuations, local historical housing price trends, geographic information and attributes of the property. The valuations may be retrieved by the valuation module 402, from a third party AVM hosted by third party server 248, or from an AVM engine hosted by the real estate marketing platform 100. Consistent with some embodiments, the one or more valuations may include current as well as historic valuations for the subject property.

At operation 520, the interface module 104 may cause the presentation of the one or more valuations on the client device 212 of the consumer. For example, FIG. 6B is an interface diagram illustrating an interface 610 for presenting multiple property valuations, according to an example embodiment. As shown, the interface 610 includes multiple valuations for a subject property 612 that corresponds to the property identifier entered in the user input field 602 discussed in reference to FIG. 6A. In particular, the interface 610 includes current valuations 614, 616, and 618 obtained from multiple third-party AVMs (e.g., Smartzip®, Zillow®, and eppraisal.com®). Each of the valuations 614, 616, and 618 may be presented as a range of values (e.g., a lower bound and a higher bound). As shown, the valuations 614, 616, and 618 may be displayed in conjunction with each other such that a consumer reviewing the valuations is presented with an indicator of the consistency of valuations provided by different AVMs. The interface 610 may also include a graph 620 representing a number of historically valuations for the subject property 612.

Returning to FIG. 5A, at operation 525, the comparables module 404 may identify one or more comparable real estate property listings based on the attributes of the subject property included in the property information accessed by the retrieval module 400. The comparable real estate property listings correspond to properties that are similar (e.g., by virtue of sharing one or more attributes) to the subject property. In some instances, the identified properties may be limited to the geographic area in which the subject property is located. Consistent with some embodiments, the identification of the one or more comparable real estate property listings may include querying a repository of property records (e.g., property record data 116) using the attributes of the subject property and retrieving a set of comparable property listings therefrom.

At operation 530, the comparables module 404 may determine an additional valuation for the subject property based on the one or more comparable property listings (e.g., a comparable valuation). The additional valuation determined by the comparables module 404 may be a statistical summation or average of the prices (listing price or sale price) of the comparable properties. For example, the comparables module 404 may calculate the mean, median, or mode of the listing prices of the identified one or more comparable property listings to determine the comparable valuation of the subject property. For purposes of this disclosure, the term “comparable property information” may be used to collectively refer to the one or more comparable property listing and the comparable valuation.

At operation 535, the user interface module 104 may cause the comparable property information to be presented on the client device of the consumer. For example, FIG. 6C is an interface diagram illustrating an interface 630 for presenting comparable property information to a consumer, according to an example embodiment. As shown, an identifier of the subject property 612 is displayed in the heading of the interface 630 along with select attributes of the subject property 612. The interface 630 includes a display of a set of comparable property listings present in a list view 632 and a map 634. The set of comparable property listings presented in the list view 632 includes comparable property listings 636 and 638, which, in this example, account for two of the twenty comparable properties in the geographic area of the subject property 612 identified by the comparables module 404.

As shown, the list view 632 of the interface 630 may provide additional details for each of the comparable properties 636 and 638 such as photos, an address, a price (e.g., sale price or listing price), and other attributes (e.g., a number of bedrooms and bathrooms, a square footage of the building, a lot size, a school district, and a sale date). The map 634 indicates the locations of all comparable properties 636 and 638 along with the location of the subject property 612. The indicators of these locations may also include a price (e.g., a sale price or a listing price) of the comparable properties 636 and 638.

The interface 630 also includes a comparable valuation 640, which may be calculated by the comparables module 404 based on the price (e.g., listing price or sold price) of the comparable properties 636 and 638. As shown, the comparable properties 636 and 638 may include a range of prices (e.g., the range of prices of the comparable properties 636 and 638—$206,000-$660,000) and a mean value for the range of prices (e.g., $478,700\).

The interface 630 is also illustrated to include various graphical elements (e.g., sliders and check boxes) that specify attribute information used to identify comparable property listings. The attribute information may, for example, include a number of bedrooms and bathrooms, a square footage, a lot size, a distance from the property, a city, or a neighborhood. Consistent with some embodiments, a consumer may modify the attribute information through manipulation of the various graphical elements. In response to receiving consumer selections of alternative attributes, the comparables module 404 may retrieve an updated set of comparable property listings using the alternative attribute information, and in conjunction with the user interface module 104, cause the display of the updated set of comparable property listings in the manner illustrated.

Returning to the method 500, at operation 540, the agent matching module 406 may identify a group of suggested agents to assist the consumer based on the property information about the subject property. The suggested agents identified by the agent matching module 406 may be based on the availability of each agent to assist the consumer. For example, the agent matching module 406 may identify a group of suggested agents based on the geographic area in which they are assigned to serve. Further, the suggested agents identified by the agent matching module 406 may be based on attributes of the agent, activities of the consumer, location of the consumer, location of the subject property, seasonality, or any combination thereof.

At operation 545, the user interface module 104 may cause a visual representation (e.g., a profile) of the group of suggested agents to be presented on the client device (e.g., client device 212) of the consumer. For example, FIG. 6D is an interface diagram illustrating a user interface 650 for presenting a group of suggested agents, according to an example embodiment. As shown, the interface 650 includes agent profiles 651-656. Each of the profiles 651-656 includes the agent's name, a picture of the agent, and an additional identifier (e.g., a realtor license number). In some instances, the agent profiles may also include an indicator of a user based rating of the agent and a selection of user reviews. The interface 650 may further include a button (e.g., button 658) or other graphical element to invoke functionality to communicatively connect the consumer with a desired agent. Upon invocation of one of these graphical elements (e.g., a consumer clicking the button 604) the consumer may be communicatively coupled with the corresponding agent via e-mail, phone call, text message, instant message, SMS, social network communication, or the like.

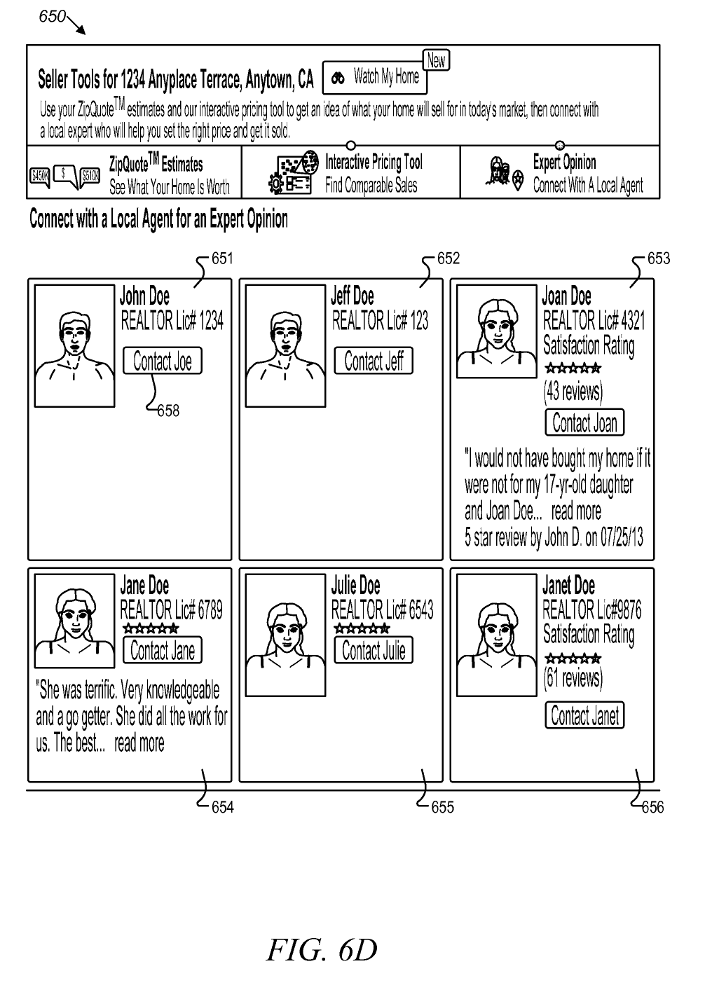

FIG. 7 is a block diagram illustrating the various functional modules forming a relationship management application 112, which is provided as part of the real estate marketing platform 100, according to an example embodiment. The relationship management application 112 is illustrated to include a scoring module 700, a segmentation module 702, a management module 704, and a communication module 706, all configured to communicate with each other (e.g., via a bus, shared memory, a switch, or application programming interfaces (APIs)). The various modules of the relationship management application 112 may, furthermore, access the databases 114 and 116, and each of the various modules of the relationship management application 112 may be in communication with one or more of the third party applications 250. Further, while the modules of FIG. 7 are discussed in the singular sense, it will be appreciated that in other embodiments multiple modules may be employed.

The scoring module 700 may be a hardware implemented module or software executed by general purpose or special purpose hardware or instructions stored on a computer readable medium that is operative to score consumers based on a level of engagement (referred to as a “engagement score”) with the real estate marketing platform 100 as evidenced by each consumer's corresponding ser activity (e.g., stored in a record in the database 114). The engagement score provides a measure of how active a consumer is on the real estate networked information system, and thus, the engagement score may indicate the likelihood of the consumer making a real estate purchase. In determining the engagement score, the scoring module 700 may assign a first weight to each user action based on the relative level of active participation in performing the action. The scoring module 700 may apply further weighting based on the timing of the action. The scoring module 700 may use an aggregation of the weighted values calculated for each action to determine the engagement score of the consumer.

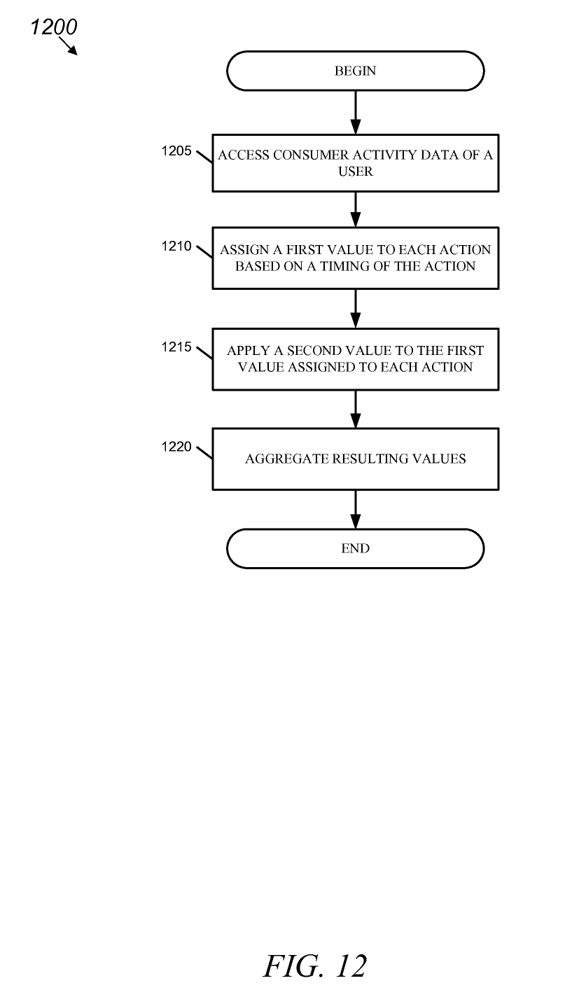

The scoring module 700 may be further configured to rank consumers according to their respective engagement scores. The rankings may provide agents with an indication of how a particular consumer's engagement level compares to another. In addition to an overall rank, the scoring module 700 may place each consumer into a coarse granular percentile rank (e.g., top 10%). These coarse granular rankings may allow an agent to more quickly navigate through a ranked list of consumers. Further details of the operations performed by the scoring module 700 are discussed below in reference to FIG. 12.

The segmentation module 702 may be a hardware implemented module or software executed by general purpose or special purpose hardware or instructions stored on a computer readable medium that is operative to segment and classify a group of consumers (e.g., from a contact pool of an agent) based on a level of engagement of each of the consumers with the real estate marketing platform 100. As discussed with reference to the determination of the engagement score, the level of engagement may be based on the user activity of the consumer, a record of which is stored in the database 114. In some embodiments, the types of user activity used by the segmentation module 702 in determining the level of engagement are actions performed by the users that involve a real estate agent. The consumer classifications employed by the segmentation module 702 may, for example, include “Prospect,” “Lead,” and “Client.”

In some instances, the segmentation module 702 may further segment a group of consumers into one or more sub-classifications. For example, within the classification of “Prospects,” the segmentation module 702 may further segment consumers into the sub-classifications of “Responsive Prospects,” (e.g., the consumer has signed into the real estate network information system within a predefined time period, and an agent has previously achieved successful contact with the consumer), “Nonresponsive Prospects,” (e.g., if the consumer has signed into the real estate network information system within a predefined time period, but has failed to respond to a communication from an agent), and “Cold Prospects” (e.g., if the consumer has not signed into the real estate network information system for a predefined time period, and the consumer has failed to respond to a communication from an agent).

In another example, within the classification of “Leads,” the segmentation module 702 may further segment consumers into the sub-classifications of “Reassigned Lead” (e.g., the consumer's last activity occurred prior to being assigned to an agent and an agent has been assigned within a predefined time period), and “New Lead” (e.g., the consumer's last activity occurred after being assigned to an agent and an agent has been assigned within a predefined time period). In yet another example, within the classification of “Clients,” the segmentation module 702 may further segment consumers into the sub-classifications of a “Closed Client” (e.g., if the consumer has a closed transaction), a “Transacting Client” (e.g., if the consumer has a pending transaction), an “Offering Client” (e.g., if the consumer has a made an offer that has not yet been accepted), a “Listing Client” (e.g., if the consumer has a real estate property listing), a “Showing Client” (e.g., if the consumer has scheduled a visit to tour a property), and a “Pre-listing Client” (e.g., if the consumer has a pending listing appointment). An example description of the basis for assigning consumers to each of the aforementioned sub-classifications is as follows:

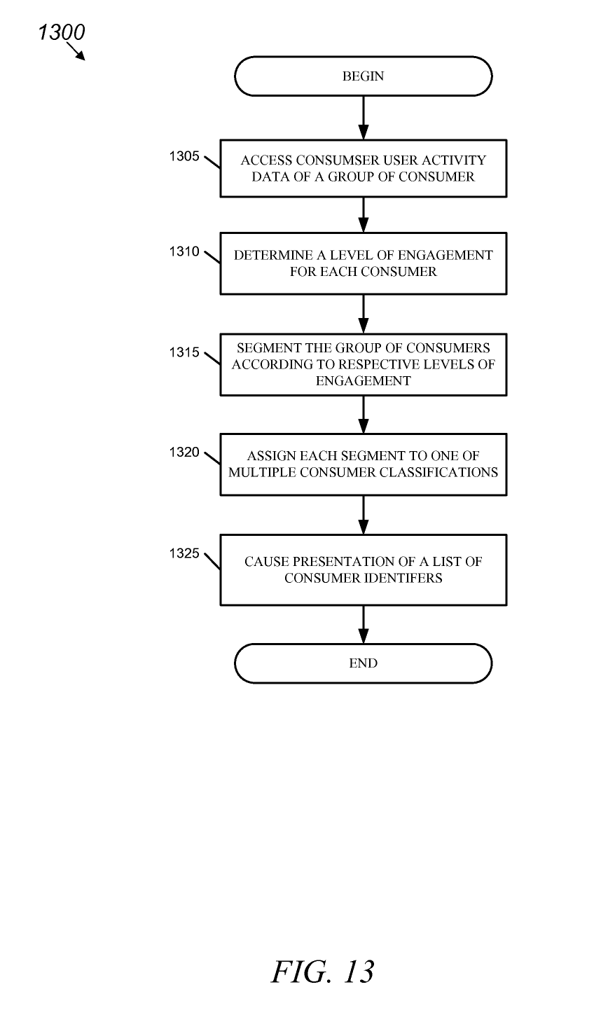

The segmentation module 702 may periodically update (e.g., daily) the classification of each consumer and in some instances, the classification of a consumer may be immediately updated in response to certain actions. For example, when a consumer schedules a visit to a property, the consumer's classification may be updated from a “Prospective Client” to “Interested Client.” Additionally, the consumer classifications may be ordered in terms of hierarchy so as to prioritize an agent's relationships. Further details of the operations of the segmentation module 702 are discussed in reference to FIG. 13.

The management module 704 may be a hardware implemented module or software executed by general purpose or special purpose hardware or instructions stored on a computer readable medium that is operative to assist agents in managing relationships with a contact pool (e.g., a group of contacts). Respective agents' contact pools may comprise consumers of the real estate marketing platform 100 assigned to the agent.

The management module 704 may work in conjunction with the interface module 104 to provide an interface, from which an agent may query a database of consumers (e.g., database 114) using desired attributes of the consumers. The management module 704 may then cause the query results (e.g., a list of consumer identifiers) to be presented in a sortable list that may include one or more graphical elements operable to invoke one or more actions with respect to one or more of the consumers included in the list. For example, the management module 704 may provide a button that when selected by an agent causes a telephone call to be made to a corresponding consumer.

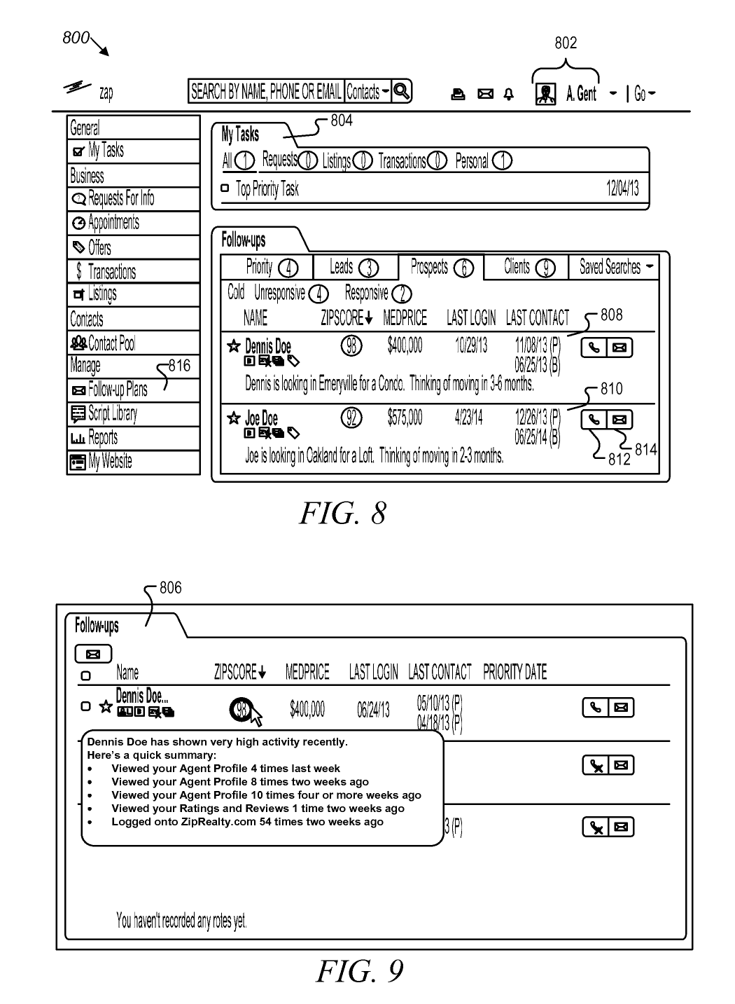

The management module 704 may work in conjunction with the interface module 104 to provide agents with multiple user interfaces for managing relationships with their contacts. Examples of such interfaces are discussed below in reference to FIGS. 9-11. The interfaces provided by the management module 704 may enable agents to define communication strategies to establish on-going communications with consumers, and in particular, their respective contact pools. A communication strategy may include one or more agent-defined parameters for contacting specified portions of a contact pool. The parameters comprising a communication strategy may, for example, include a limit on the number of contacts to be contact, a type of contact relationship (e.g., a consumer classification and a sub-classification), a threshold engagement score, and a frequency at which the contacts should be contacted. Communication strategies may also specify a scripted message or a series of scripted messages for communicating with the specified portions of the contact pool. The scripted messages specified by such communication strategies may be selected from a list of available scripted messages, and may be customized for a particular agent, brokerage, or a local market. The content of each scripted message may be further refined based on the consumer classifications.

The management module 704 may work in conjunction with the communication module 706 to automatically transmit the scripted messages in accordance with the communication strategy (e.g., messages are transmitted to the specified portions of a contact pool at time intervals corresponding to the specified frequency). The communication module 706 may be a hardware implemented module or software executed by general purpose or special purpose hardware or instructions stored on a computer readable medium that is operative to delivery messages to the users (e.g., consumers and agents) of the real estate marketing platform 100. The messages may be sent in a variety of formats including electronic mail (e-mail), instant message (IM), short message service (SMS), text, facsimile, or voice (e.g., Voice over IP (VoIP)). To this end, the communication module 706 may utilize any number of delivery networks and messaging platforms to deliver messages to users. For example, the communication module 706 may deliver messages via wired (e.g., the Internet), plain old telephone service (POTS), or wireless (e.g., mobile, cellular, WiFi, WiMAX) networks.

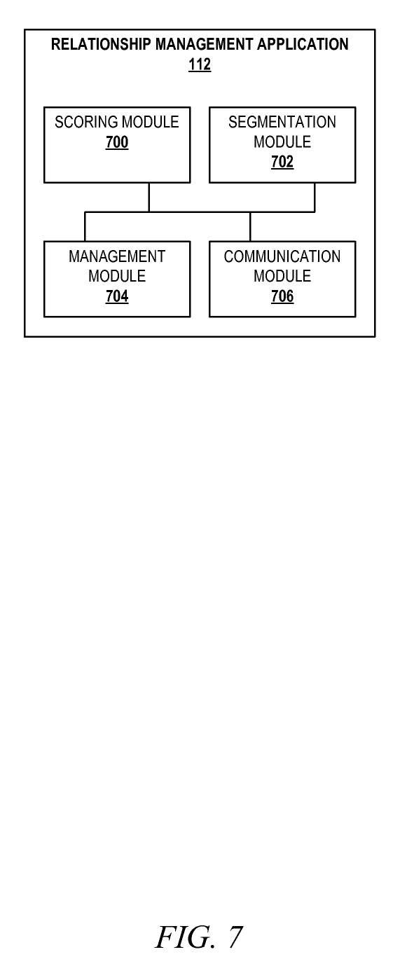

FIG. 8 is an interface diagram illustrating an interface 800 for managing relationships with a contact pool of a real estate agent 802, according to an example embodiment. As shown, the interface 800 may include a task list 804 comprising tasks assigned to the agent 802. The tasks displayed on the task list 804 may be filtered according to category (e.g., requests, listings, transactions, or personal). The agent 802 may filter the task list 804 by selecting an applicable task category tab presented in an interface element on a left side of the agent dashboard.

As shown, the interface 800 includes a contact list 806 comprising entries 808 and 810 corresponding to two contacts of the contact pool of the real estate agent 802. Within each of the entries 808 and 810, each contact may be identified by name or other identifier (e.g., an e-mail address, account number). Each entry 808 and 810 may include additional information for each contact such as an engagement score (e.g., calculated by the scoring module 700), a median price, a date of last login, dates of previous contact, and a priority date may be displayed. Each of the entries 808 and 810 also include textual notes that may be added by the agent 802 to make note of a consumer's preferences. The textual notes may be edited by the agent 802 at any time, and may contain information such as the cities or neighborhoods a consumer has searched for real estate in, or certain property attributes (e.g., a number of beds, number of baths, or square footage) of properties they have viewed or are looking for. Additional detailed information about each contact (e.g., a contact profile) may be presented upon selection of the identifier of the contact.

The contact list 806 may be sorted according to a variety of parameters to assist agents 802 to identify particular contacts or a particular subset of the contact pool. For example, the contact list 806 may be ranked according to engagement score. The contact list 806 may also be sorted according to one or more consumer classifications (e.g., priority, leads, prospects, and clients) through user (e.g., real estate agent 802) selection of the applicable tab presented at the top of the contact list 806. Each classification may include a sub-classification (e.g., cold, unresponsive, responsive). The classification and sub-classification assigned to each consumer may be based on the respective activity of the contact. The contact list 806 may also be sorted according the median price, the date or time of last login, or the data of previous contact.

The interface 800 may further include one or more graphical user interface (GUI) elements that, when instantiated, may invoke communicative functionality (e.g., e-mail or phone call). For example, the interface 800 includes buttons 812 and 814 for invoking such communicative functionality with respect to individual consumers included in the contact list 806. Upon selection of the button 812, the communication module 706 may cause a phone call to be placed to a phone number listed in the corresponding contact's profile, and relationship management application 112 may present an additional window with a follow-up tip and a script to assist the agent 802 in making the phone call to the contact. The additional window may further include a field for the agent 802 to record notes related to the call and a check box (or similar GUI element) for indicating that the phone call occurred. The contact contacted by the agent 802 may be surfaced to a higher position on the ranked contact list 806 in response to the phone call being placed. Upon selection of the button 814, an e-mail may be automatically generated using a script from the script repository in accordance with a communication strategy established by the agent 802. Prior to transmitting the message to the corresponding contact, the agent 802 may edit the message or select a different script. The transmission of the message may automatically be recorded for later viewing under the “All Communications” tab.

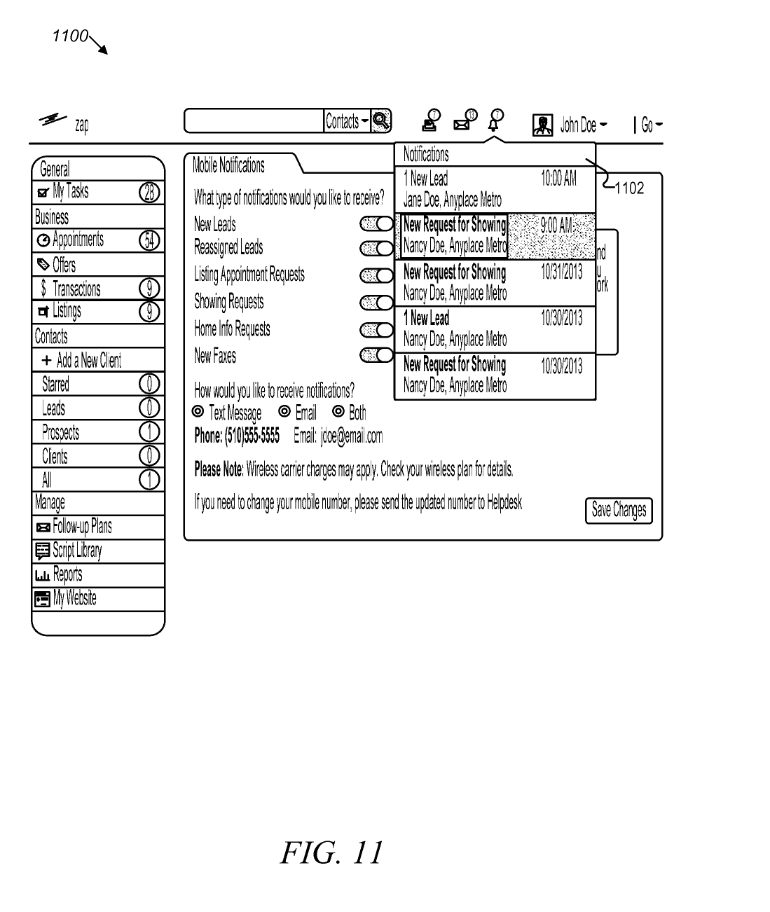

In some embodiments, the particular contacts displayed within each classification (or sub-classification) may depend on a communication strategy established by the agent 802. For example, the real estate agent 802 may define the communication strategy such that contacts classified as “New Leads” may be presented every few days, while consumers classified as “Active Prospects” may only be presented every two weeks. An interface for configuring a communication strategy may be presented upon selection of tab 816 (labeled “Follow-Up Plans”) displayed to the left of the contact list 806. An example of such an interface is described below in reference to FIG. 11.

In some embodiments, the interface 800 may include a view or indication of the most recent communications (e.g., the five most recently sent e-mails by the agent 802) transmitted to the contact pool. Additionally, the interface 800 may allow the agent 802 to access reports generated by the real estate marketing platform 100 related to the agent 802's activity and the respective activity of the contact pool of the agent 802.

FIG. 9 is an interface diagram illustrating further details of a portion of the interface 800 for managing relationships of the real estate agent 802, according to an example embodiment. In particular, FIG. 9 illustrates additional details with respect to information presented in the contact list 806. As shown and discussed above, the engagement score (illustrated as “ZIPSCORE”) of each contact may be in the contact list 806. A user (e.g., the agent 802) selecting or hovering over the engagement score with a pointing device (e.g. a mouse) or touch-based gesture (e.g., on a capacitive touch screen) may cause a display of an additional window that includes details of specific activities performed by the contact that serve as a basis for the contact's engagement score. In some embodiments, the specific activates displayed may be the most recent activates performed by the contact.

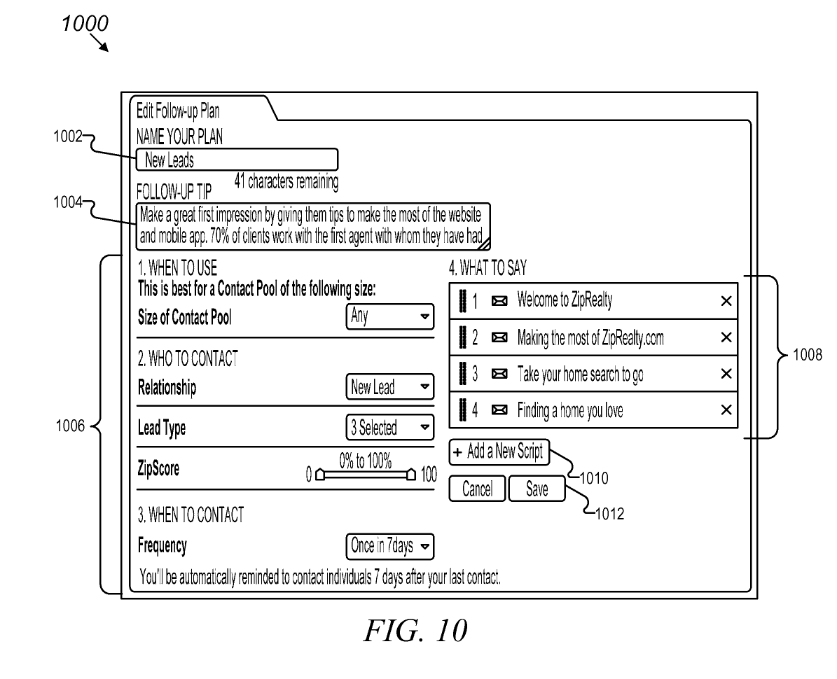

FIG. 10 is an interface diagram illustrating an interface 1000 for establishing a communication strategy for a group of contacts, according to an example embodiment. As shown, the interface 1000 includes a field 1002 for naming the communication strategy. The interface 1000 may further include a field 1004 containing advice pertinent to the communications scheduled as part of the communication strategy.

The agent 802 configuring the communication strategy may wish to target a certain group of consumers from his contact pool for certain types of communications (e.g., using a particular script). To achieve this, the interface 1000 includes parameters 1006 which may be configured by the agent 802 to create a narrower group of contacts for which on-going communications will be scheduled. The parameters 1006 may, for example, include a size of the pool (e.g., the number of consumers to be contacted), the relationship of the consumers to the agent 802 (e.g., consumer classifications), a sub-classification (“Lead Type” in this example), a frequency, and a range or threshold of engagement scores (illustrated as “ZipScore”).

The interface 1000 may further include a collection of message scripts 1008 comprising a series of message scripts that will be used to communicate with the group of contacts specified by the parameters 1006. The message scripts included in the collection of message scripts 1008 may be automatically retrieved (e.g., by the management module 704) from a message script repository (e.g., stored in the database 114 or 116) based on the parameters 1006 specified by the agent 802. In this manner, the particular scripts included in the collection of message scripts 1008 are customized for the group of contacts. These message scripts 1008 are customized in the sense that they include information tailored to the specified group of contacts. For example, the collection of message scripts 1008 for a communication strategy directed to “New Leads” may include a message script for welcoming the new user and may provide additional information regarding the services offered by the real estate marketing platform 100. At the time of transmitting a particular message from the collection of message scripts 1008, the management module 704 may further customize the message for each particular contact in the specified group of contacts. For example, messages may be customized to include the contact's name and other information about the consumer such as a location of the contact or references to activities performed by the contact. In this manner, from the perspective of the recipient, the message will appear as if it were thoughtfully drafted by the agent 802 particularly for the recipient.

The agent 802 may also be allowed to edit any one of the messages included in the collection of message scripts 1008 (e.g., via an additional interface presented in response to selection of a particular message script) prior to saving the communication strategy. The agent 802 may also be able to access the message script repository through selection of button 1010. The agent 802 may then be able to select one or more additional message scripts to include in the collection of message scripts 1008. Upon selection of button 1012, the communication strategy may be saved and applied to the specified group of contacts. Once a communication strategy is applied to a group of contacts, the management module 704 may work in conjunction with the communication module 706 to automatically transmit, without further interaction from the agent 802, each message in the collection of message scripts 1008 to the specified group of contacts in accordance with the communication strategy. For example, the communication module 706 may transmit the series of message scripts 1008 in the specified order and at time intervals corresponding to the frequency attribute.

FIG. 11 is an interface diagram illustrating an interface 1100 for displaying notifications provided by the real estate marketing platform 100, according to an example embodiment. As shown, the interface 1100 includes a drop down window 1102 comprising multiple indicators (e.g., icons) to alert a user (e.g., an agent) of pending notifications. The notifications may be of varied types and may relate to activities of consumers, received communications, or pending tasks of the agent. For each type of notification a number may be presented to indicate the number of new notifications of that type. Upon selection of one of the notification indicators presented in the drop down window 1102, a list of all notifications (old and new) of the particular type may be displayed.

New notifications may be visually distinguished (e.g., bolded, shaded, different color) from old notifications. Notifications may be displayed for a given time period (e.g., 7 days). A detail view of a notification may be presented in response to selection of the notification. Notifications may, for example, include “New Lead,” “Lead Reassigned,” “Listing Appointment Requested,” “Showing Requested,” “Request for Information,” “New E-mail Received,” “Phone Call Received,” and “New Fax Received.”

As illustrated in FIG. 11, the interface 1100 may also include a number of configurable parameters to allow an agent to define the types of notifications he or she will receive and the manner in which the notifications will be received (e.g., text message, e-mail, or both). It shall be appreciated that although the drop down menu 1102 is illustrated as being part of the interface 1100, the drop down menu 1102 is not limited to the interface 1100, and may also be included with any of the interfaces discussed herein. Further, in some embodiments, the drop down menu 1102 may be displayed as an independent screen in a mobile application (e.g., mobile application 208) designed for use with the real estate marketing platform 100.

FIG. 12 is a flowchart illustrating a method 1200 for determining an engagement score, according to an example embodiment. The method 1200 may be embodied in computer-readable instructions for execution by one or more processors such that the steps of the method 1200 may be performed in part or in whole by the relationship management application 112. In particular, the method 1200 may be carried out by the scoring module 700 of the relationship management application 112, and accordingly, the method 1200 is described below by way of example with reference thereto. However, it shall be appreciated that the method 1200 may be deployed on various other hardware configurations and is not intended to be limited to the scoring module 700.

At operation 1205, the scoring module 700 may access consumer activity data of a particular consumer (e.g., from the database 114) representative of activity (e.g., one or more actions) of the consumer with respect to the real estate marketing platform 100. In some embodiments, the scoring module 700 may access a subset of the consumer activity data of the consumer. The subset of consumer activity data may represent actions performed within a certain time period or may relate to specific types of actions such as actions for which the level of engagement is above a predefined threshold. For example, the scoring module 700 may access consumer activity data representative of the following actions: viewing an agent profile; viewing an agent's ratings; scheduling a showing; requesting more information; saving a property listing; viewing driving directions; sharing a property listing on a social network; logging into a mobile application; marking a property as a ‘favorite’; subscribing to e-mail alerts; saving a search; subscribing to alerts; printing a property listing; logging on to a user account provided by the real estate information service 106; or viewing a home detail page.

At operation 1210, the scoring module 700 may assign a first value to each action based on a timing of the action. In this manner, the scoring module 700 may provide a weight to each of the consumer's actions based on a recency of their performance. In an example, the scoring module 700 may assign actions performed within the previous seven days with a value of 5, actions performed in the last eight to fourteen days with a value of 3, actions performed in the last fifteen to twenty days with a value of 1.5, actions performed in the last twenty-one to twenty-seven days with a value of 0.75, and actions performed in the last twenty-eight to thirty days with a value of 0.3.

At operation 1215, the scoring module 700 may, for each action, apply a second value to the first value assigned to the action. The result of the application of the second value to the first value is a third value that provides an overall weighting for each action based on a combination of recency and level of engagement. For example, the scoring module 700 may multiply the first value by the second value. The second value applied by the scoring module 700 is based on the level of active user participation involved in each action. In this manner, each of the actions performed by the consumer is provided additional weight based on the amount of user engagement involved in the action. An action that shows high engagement, such as viewing a ratings page for an agent, will be weighted higher than a less engaged action such as simply viewing a property listing page. Each action may have a corresponding predefined second value that is set according to the level of engagement of that action. For example, the action of viewing driving directions for a property may have a corresponding second value of 5, and the action of requesting additional information about a property may have a corresponding second value of 20.

At operation 1220, the scoring module 700 may aggregate (e.g., sum) the respective resulting values (the third value) for each action to calculate the engagement score of the consumer. In some embodiments, the interface module 104 may cause the engagement score to be presented (e.g., on client device 210). For example, the engagement scores for each contact in an agent's contact pool may be displayed in a list that may be filtered, ranked, or sorted according to the engagement score. In some embodiments, such a list may be presented as part of an interface provided by the management module 704 for managing relationships of a real estate agent.

FIG. 13 is a flowchart illustrating a method for assigning a group of consumers to applicable consumer classifications, according to an example embodiment. The method 1300 may be embodied in computer-readable instructions for execution by one or more processors such that the steps of the method 1300 may be performed in part or in whole by the relationship management application 112. In particular, the method 1300 may be carried out by the segmentation module 702 of the relationship management application 112, and accordingly, the method 1300 is described below by way of example with reference thereto. However, it shall be appreciated that the method 1300 may be deployed on various other hardware configurations and is not intended to be limited to the segmentation module 702.

At operation 1305, the segmentation module 702 may access consumer activity data of a group of consumers (e.g., from the database 114) representative of activity (e.g., one or more actions) of each of the consumers with respect to the real estate marketing platform 100. The group of consumers may, for example, be a contact pool of an agent.

At operation 1310, the segmentation module 702 may determine a level of engagement of each consumer of the group of consumers based on their respective activity (e.g., represented by the consumer activity data). The types of user activity used by the segmentation module 702 in determining the level of engagement may be a set of actions performed by the consumers that specifically involve a real estate agent (e.g., responding to messages from an real estate agent, scheduling a tour or other appointment with a real estate agent, transacting with a real estate agent, or the like). In some embodiments, the segmentation module 702 may utilized the engagement score of each consumer (e.g., determined by the scoring module 700) as a proxy for the level of engagement.

At operation 1315, the segmentation module 702 may segment the group of consumers according to their respective levels of engagement. At operation 1320, the segmentation module 702 may assign each resulting segment of consumers to one of multiple consumer classifications (e.g., client, lead, or prospect). Further examples of consumer classifications are discussed above with reference to FIG. 7.

At operation 1325, the user interface module 104 may cause presentation of a list of consumer identifiers (corresponding to the group of consumers) that is organized according to the consumer classifications. For example, the list may be presented in an interface such as the interface 800, which has multiple tabs, each representing a consumer classification.

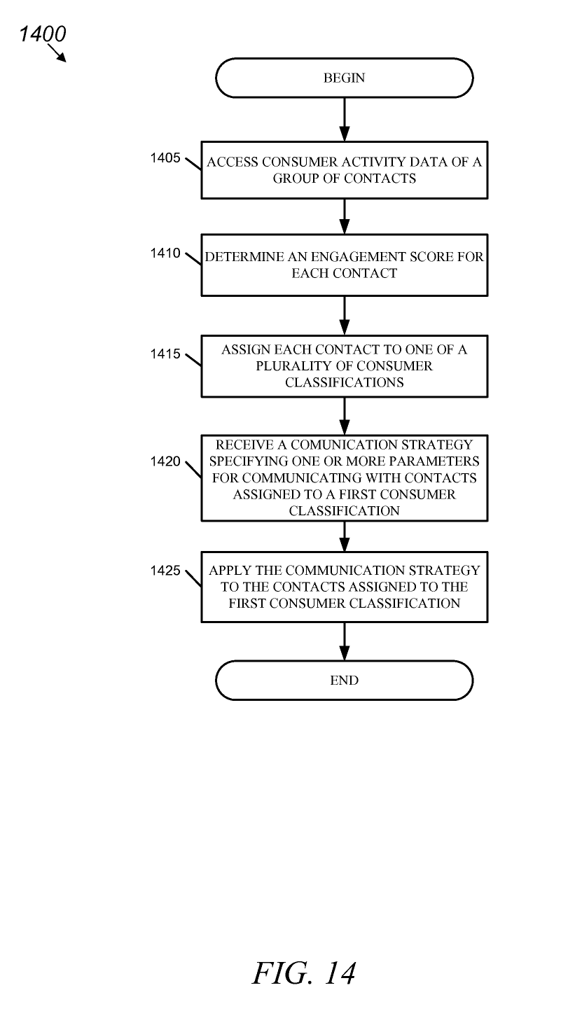

FIG. 14 is a flowchart illustrating a method 1400 for managing relationships of a real estate agent, according to an example embodiment. The method 1400 may be embodied in computer-readable instructions for execution by one or more processors such that the steps of the method 1400 may be performed in part or in whole by the relationship management application 112. In particular, the method 1400 may be carried out by the various modules forming the relationship management application 112, and accordingly, the method 1400 is described below by way of example with reference thereto. However, it shall be appreciated that the method 1400 may be deployed on various other hardware configurations and is not intended to be limited to the modules of the relationship management application 112.

At operation 1405, the management module 704 accesses consumer activity of a group of contacts of a real estate agent. The group of contacts may comprise consumers of the real estate marketing platform 100 that are assigned or otherwise associated with the agent.

At operation 1410, which is optional in some embodiments, the scoring module 700 may determine an engagement score for each contact in the group of contacts according to the methodologies discussed herein.

At operation 1415, the segmentation module 702 assigns each contact of the group of contacts to one of a plurality of consumer classifications (e.g., client, lead, or prospect) according to the methodologies discussed herein.

At operation 1420, the management module 704 receives, from a client device (e.g., client device 210) operated by the agent, a communication strategy specifying one or more parameters for communicating with contacts from the group of contacts that have been assigned to a first consumer classification of the plurality of consumer classifications. The communication strategy may specify one or more message scripts to be transmitted to said contacts, and may further specify one or more parameters (e.g., a frequency) for contacting the contacts. The management module 704 may receive the communication strategy from the agent via an interface provided by the interface module 104 such as the interface 1100 discussed in reference to FIG. 11.

At operation 1425, the management module 704 implements the received communication strategy with respect to the contacts assigned to the first consumer classification. The implementation of the communication strategy includes causing the communication module 706 to automatically transmit, without further interaction by the real estate agent, the one or more scripted messages to the contacts in accordance with the parameters of the communication strategy. In some embodiments, the communication module 706 may automatically transmit, without further interaction by the real estate agent, a series of scripted messages to the contacts assigned to the first consumer classification at time intervals specified by the frequency parameter of the communication strategy.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, for example, a computer program tangibly embodied in an information carrier, for example, in a machine-readable medium for execution by, or to control the operation of, data processing apparatus, for example, a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Machine Architecture and Machine-Readable Medium

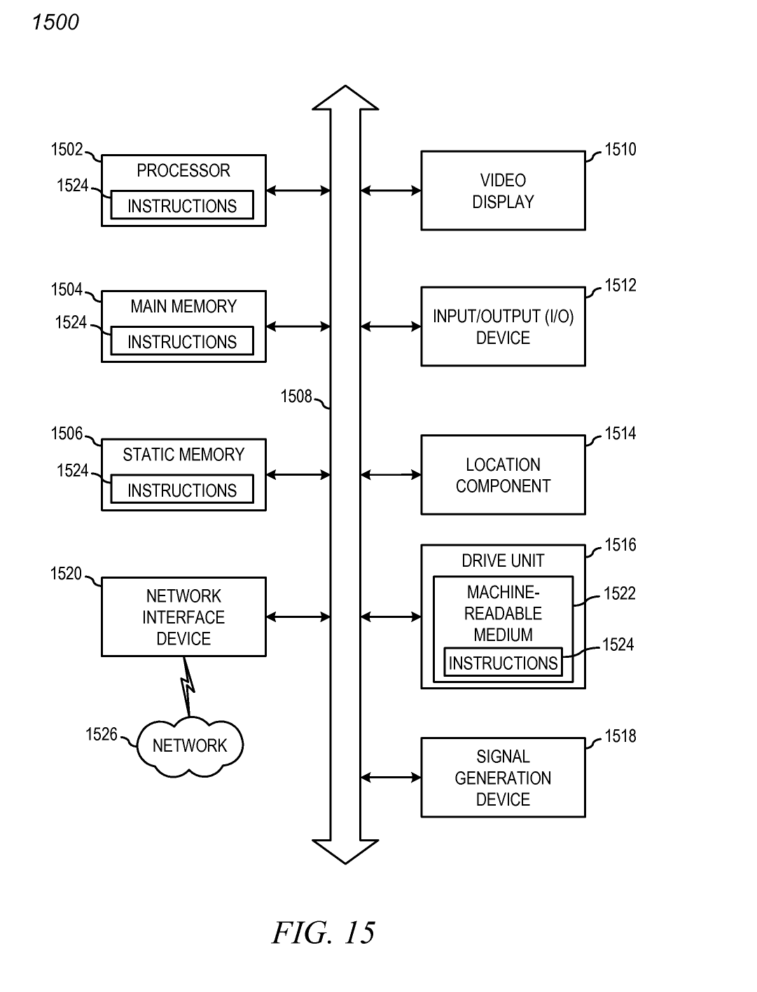

FIG. 15 is a block diagram of a machine in the example form of a computer system 1500 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a PDA, a cellular telephone, a smart phone (e.g., iPhone®), a tablet computer, a web appliance, a handheld computer, a desktop computer, a laptop or netbook, a set-top box (STB) such as provided by cable or satellite content providers, a wearable computing device such as glasses or a wristwatch, a multimedia device embedded in an automobile, a Global Positioning System (GPS) device, a data enabled book reader, a video game system console, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Consistent with some embodiments, the computer system 1500 may correspond to the client device 210 and 212, the third party server 248 or any of the servers 216-238.

The example computer system 1500 includes a processor 1502 (e.g., a central processing unit (CPU), a graphics processing unit (GPU) or both), a main memory 1504 and a static memory 1506, which communicate with each other via a bus 1508. The computer system 1500 may further include a video display unit 1510 (e.g., a liquid crystal display (LCD) or a cathode ray tube (CRT)). The computer system 1500 also includes one or more input/output (I/O) devices 1512, a location component 1514 (e.g., a GPS device), a disk drive unit 1516, a signal generation device 1518 (e.g., a speaker) and a network interface device 1520. The one or more I/O devices 1512 may, for example, include a keyboard, a mouse, a keypad, a multi-touch surface (e.g., a touchscreen or track pad), a microphone, a camera, or the like.

The location component 1514 may be used for determining a location of the computer system 1500. In some embodiments, the location component 1514 may correspond to a GPS transceiver that may make use of the network interface device 1520 to communicate GPS signals with a GPS satellite. Consistent with some embodiments, the location component 1514 may also be configured to determine a location of the computer system 1500 by using an internet protocol (IP) address lookup or by triangulating a position based on nearby mobile communications towers. The location component 1514 may be further configured to store a user-defined location in main memory 1504 or static memory 1506. In some embodiments, a mobile location enabled application may work in conjunction with the location component 1514 and the network interface device 1520 to transmit the location of the computer system 1500 to an application server or third party server 248 for the purpose of identifying the location of a user operating the computer system 1500.

In some embodiments, the network interface device 1520 may correspond to a transceiver and antenna. The transceiver may be configured to both transmit and receive cellular network signals, wireless data signals, or other types of signals via the antenna, depending on the nature of the computer system 1500.

### Machine-Readable Medium

The disk drive unit 1516 includes a machine-readable medium 1522 on which is stored one or more sets of instructions and data structures (e.g., software) 1524 embodying or used by any one or more of the methodologies or functions described herein. The instructions 1524 may also reside, completely or at least partially, within the main memory 1504, static memory 1506, and/or within the processor 1502 during execution thereof by the computer system 1500, the main memory 1504, static memory 1506 and the processor 1502 also constituting machine-readable media 1522.

Consistent with some embodiments, the instructions 1524 may relate to the operations of an operating system. Depending on the particular type of the computer system 1500, the OS may, for example, be the iOS® operating system, the Android® operating system, a BlackBerry® operating system, the Microsoft® Windows® Phone operating system, Symbian® OS, or webOS®. Further, the instructions 1524 may relate to operations performed by applications (commonly known as “apps”), consistent with some embodiments. One example of such an application is a mobile browser application that displays content, such as a web page or a user interface using a browser.

While the machine-readable medium 1522 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present disclosure, or that is capable of storing, encoding or carrying data structures used by or associated with such instructions. The term “machine-readable medium” shall accordingly be taken to include, but not be limited to, solid-state memories, and optical and magnetic media. Specific examples of machine-readable media include non-volatile memory, including by way of example, semiconductor memory devices (e.g., erasable programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

Furthermore, the tangible machine-readable medium is non-transitory in that it does not embody a propagating signal. However, labeling the tangible machine-readable medium as “non-transitory” should not be construed to mean that the medium is incapable of movement—the medium should be considered as being transportable from one real-world location to another. Additionally, since the machine-readable medium is tangible, the medium may be considered to be a machine-readable device.

### Transmission Medium

The instructions 1524 may further be transmitted or received over a communications network 1526 using a transmission medium. The instructions 1524 may be transmitted using the network interface device 1520 and any one of a number of well-known transfer protocols (e.g., HTTP). Examples of communication networks 1526 include a LAN, a WAN, the Internet, mobile telephone networks, plain old telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although the present invention has been described with reference to specific example embodiments, it will be evident that various modifications and changes may be made to these embodiments without departing from the broader scope of the invention. Accordingly, the specification and drawings are to be regarded in an illustrative rather than a restrictive sense.

Although an embodiment has been described with reference to specific example embodiments, it will be evident that various modifications and changes may be made to these embodiments without departing from the broader scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim. Moreover, in the following claims, the terms “first,” “second,” and “third,” and so forth are used merely as labels, and are not intended to impose numerical requirements on their objects.

What is claimed is:

1. A method comprising:
accessing consumer activity data of contacts of a real estate agent, the consumer activity data representing actions performed by the contacts while using a network-based real estate information service;
assigning, using a processor of a machine, each of the contacts to one of a plurality of consumer classifications based on the actions performed by each of the contacts;
receiving, from the real estate agent, a communication strategy specifying one or more parameters for communicating with contacts assigned to a first consumer classification of the plurality of consumer classifications; and
implementing the communication strategy with respect to the contacts assigned to the first consumer classification of the plurality of consumer classifications.

2. The method of claim 1, further comprising causing presentation of a list of identifiers of the contacts of the real estate agent, the presentation of the list of identifiers being organized according to the plurality of consumer classifications.

3. The method of claim 2, further comprising filtering the list according to respective engagement scores of each of the contacts.

4. The method of claim 3, further comprising determining the respective engagement score of each of the contacts, the determining of the engagement score comprising:
assigning a first value to each action performed by each of the contacts based on a level of engagement of the action;
applying a second value to the first value assigned to each action, the second value being based on a timing of the action; and
aggregating resulting values of each action to determine the engagement score.

5. The method of claim 1, wherein the one or more parameters limit communication to the contacts having an engagement score within of a particular range.

6. The method of claim 1, wherein the assigning of the contacts to one of the plurality of consumer classifications comprises:
determining a level of engagement of each of the contacts based on the respective actions performed by the contacts;
segmenting the contacts according to the respective levels of engagement of each of the contacts; and
assigning each segment of the contacts to one of the plurality of consumer classifications.

7. The method of claim 1, wherein the plurality of consumer classifications include prospects, leads, and clients.

8. The method of claim 1, wherein the communication strategy specifies one or more message scripts to be transmitted to the contacts assigned to the first consumer classification in accordance with the one or more parameters.

9. The method of claim 1, wherein the one or more parameters include a frequency for contacting the contacts assigned to the first consumer classification.

10. The method of claim 1, wherein the applying of the communication strategy includes automatically transmitting, without further interaction by the agent, a scripted message to the contacts assigned to the first consumer classification in accordance with the communication strategy.

11. A system comprising:
a processor of a machine;
a machine-readable storage medium to store consumer activity data of a group of contacts of a real estate agent, the consumer activity data representing actions performed by the group of contacts while using a network-based real estate information service;
a segmentation module configured to assign each member of the group of contacts to one of a plurality of consumer classifications based on the respective actions performed by each member of the group of contacts;
a management module configured to receive, from the real estate agent, a communication strategy specifying one or more parameters for communicating with a portion of the group of contacts belonging to a first consumer classification of the plurality of consumer classifications; and
a communication module configured to transmit, without further interaction by the agent, a scripted message to the portion of the group of contacts in accordance with the communication strategy.

12. The system of claim 11, further comprising a user interface module configured to cause presentation of a list of contact identifiers corresponding to the group of contacts, the presentation of the list of contact identifiers being organized according to the plurality of consumer classifications

13. The system of claim 11, wherein the segmentation module is further to assign each member of the group of contacts to one of a plurality of sub-classifications within each of the plurality of consumer classifications.

14. The system of claim 13, wherein the one or more parameters limit communication to members of the group of contacts that belong to a particular sub-classification within the first consumer classification.

15. The system of claim 11, wherein the scripted message is specified by the real estate agent and included in the communication strategy.

16. The system of claim 11, wherein the scripted message is a first scripted message in a series of scripted messages tailored for the first consumer classification.

17. The system of claim 11, wherein the one or more parameters include a frequency for transmitting the scripted message to the portion of the group of contacts.

18. A tangible machine-readable storage medium embodying instructions that, when executed by one or more processors of a machine, cause the machine to perform operations comprising:
accessing consumer activity data of contacts of a real estate agent, the consumer activity data representing actions performed by the contacts while using a network-based real estate information service;
assigning each of the contacts to one of a plurality of consumer classifications based on the actions performed by the contacts;
receiving, from the real estate agent, a communication strategy specifying one or more parameters for communicating with the contacts of the real estate agent assigned to a first consumer classification of the plurality of consumer classifications, the communication strategy further specifying a series of scripted messages for communicating with the contacts assigned to the first consumer classification; and
automatically transmitting, without further interaction by the agent, a first scripted message of the series of scripted messages to the contacts of the first consumer classification in accordance with the communication strategy.

19. The non-transitory machine-readable storage medium of claim 18, wherein the one or more parameters include a frequency with which the contacts assigned to the first consumer classification are contacted.

20. The non-transitory machine-readable storage medium of claim 19, further comprising routinely transmitting, without further interaction by the real estate agent, a remainder of a series of scripted messages at time intervals corresponding to the frequency specified by the communication strategy.
